(19) United States
(12) Patent Application Publication
(10) Pub. No.: US 2007/0058188 A1
(43) Pub. Date: Mar. 15, 2007

(54) Image forming apparatus, image forming method, and image forming program

(75) Inventor: Nobuhiko Nakahara, Susono-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/225,194

(22) Filed: Sep. 14, 2005

(51) Int. Cl. G06F 3/12

(52) U.S. Cl. 358/1.13; 358/1.14

(57) ABSTRACT

According to one aspect of the present invention, there is provided an image forming apparatus comprising an analyzer analyzing an attribute of an object contained in image data, a toner limiter limiting several toners supplies corresponding to several color components based on an attribute of the object analyzed by the analyzer, and an image forming unit forming an image based on an object contained in the image data using the toner limited by the toner limiter.

### BACKGROUND OF THE INVENTION

1. Field of the Invention

The present invention relates to various image forming apparatuses such as copier, printer and FAX. Moreover, the present invention relates to image forming method and image forming program applied to these image forming apparatuses.

2. Description of the Related Art

Recently, various image forming apparatuses have come into wise use, and typically, a MFP (multi-function printer) is given. The MFP integrally handles digitized image data using various functions such as copier, printer, scanner and FAX. Moreover, the MFP temporarily stores the image data in a storage medium such as HDD, and reuses it. In the MFP given as a typical example, that is, in the image forming apparatus, the following requirements are given as a very important development item. First, it is necessary to establish architecture of simply and seamlessly handling various data. Secondary, it is necessary to reduce the apparatus cost and toner consumption.

In general, if the image forming apparatus handles a color image, part of a computer terminal, that is, monitor handles an image according to 8-bit RGB calorimetric system. On the other hand, a printer handles the image according to 8-bit CMY or CMYK calorimetric system. Usually, the monitor modulates the luminance of the image every RGB to purely display one pixel at multi-level gradations. However, a typical printer, that is, output device finally uses half tone techniques such as dither method using threshold matrix or density pattern method. Basically, dot on/off, that is, binary output is controlled in a predetermined micro area at a unit of pixel or at a unit further dividing the pixel, and thereby, gradation is reproduced in the area. Four colors, that is, C (cyan), M (magenta), Y (yellow) and K (black) are applied as the color. Or three colors, that is, C (cyan), M (magenta) and Y (yellow) are applied as the color. Three or four color microdots are overlapped on the final print surface, thereby reproducing an image having fine color gradation. However, K produced by overlapping each coloring material of CMY actually has no ideal K color characteristic. For this reason, most of general color image output devices produce color based on CMYK. A host computer or personal computer creates and edits document, graphics and photograph. These document, graphics and photograph are converted into PDL (e.g., postscript and PCL) by a printer driver, and thereafter, supplied to an image output device via relay means such as LAN and USB. The image output device interprets the language using a controller, and then, executes processing of developing it into raster data (RIP). In general, the controller executes color conversion and half tone processing. Image data outputted from the controller has one pixel 1-bit to 8-bit per color. In other words, the controller outputs image data equivalent to gradation reproduction performance corresponding to the print capacity of the output device.

In a general color output device, if four-color toners are locally arranged with a predetermined amount, a toner peel-off phenomenon calling offset happens. The phenomenon is a factor of remarkably reducing the image quality while giving damages to a printer engine. Basically, the following measures are taken to solve the foregoing toner problem. Specifically, a three-dimensional table considering the maximum toner is prepared when making a color conversion design, and a toner limitation circuit is additionally provided. In general, if CMYK fill color is all set to 400% in electrophotography, the toner limitation amount is about 200 to 300%. Therefore, a high definition color image is reproduced using a color area at the maximum in the foregoing range.

Generally, an image outputted from a printer is produced based on digital data generated by various applications operating on a PC. The digital data generated by various applications is transferred to a controller of an image forming apparatus via a printer driver. Then, the digital data is accurately rasterized by the controller, and thereafter, printed out. For this reason, the controller need to handle complicate and various objects, and moreover, various rasterized images must be accurately reproduced. In this case, all image information must be accurately given in its color reproduction. On the other hand, in image data, there exist many objects, which is not so important as color information. In particular, if the object has very high density, conversely, the following problems arise. Specifically, the outputted image is hard to be visible, or toner is wastefully consumed. Nowadays, people have an awareness of the problem of wastefully consuming toner in the light of consideration to environment.

For this reason, there has been made a development of changing process setting and improving toner characteristic to reduce toner consumption. On the other hand, a technique of reducing the toner consumption has been proposed in image processing. According to the technique, in a monochrome machine, masking of various images or character/line drawing is subjected to thinning, thereby reducing the toner consumption. In a color machine, image processing γ is changed, and fill MAX is limited, thereby reducing the toner consumption.

### BRIEF SUMMARY OF THE INVENTION

An object of the present invention is to provide image forming apparatus, method and program, which are excellent in reduction of toner consumption.

In an aspect of the present invention, an image forming apparatus comprises an analyzer analyzing an attribute of an object contained in image data, a toner limiter limiting the supply of several toners corresponding to several color components based on an attribute of the object analyzed by the analyzer, and an image forming unit forming an image based on an object contained in the image data using the toner limited by the toner limiter.

In another aspect of the present invention, an image forming apparatus comprises an input setting unit setting the input of toner supply limit data for limiting the supply of several toners corresponding to several color components based on an attribute of an object contained in image data, an analyzer analyzing an attribute of the object contained in the image data, a toner limiter limiting the supply of several toner corresponding to several color components based on the toner supply limit data set by the input setting unit and the attribute of the object analyzed by the analyzer, and an image forming unit forming an image based on an object contained in the image data using the toner limited by the toner limiter.

In another aspect of the present invention, an image forming program comprises a procedure of setting the input of toner supply limit data for limiting the supply of several toners corresponding to several color components based on an attribute of an object contained in image data, and a procedure of outputting an instruction to form an image based on an object contained in the image data using a toner limited by the toner supply limit data.

In another aspect of the present invention, an image forming method comprises analyzing an attribute of an object contained in image data, limiting the supply of several toners corresponding to several color components based on an attribute of the analyzed object, and forming an image based on an object contained in the image data using the limited.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing the configuration of a MFP and showing the environmental layout of the MFP;

FIG. 2 is a view showing the configuration of a first image processing block of a MFP;

FIG. 3 is a view showing one example of half tone pixel print;

FIG. 4 is a flowchart to explain the algorithm of toner limit processing by a toner limit processor;

FIG. 5 is a block diagram schematically showing the configuration of a toner limit processor;

FIG. 6 is a view showing the configuration of a second image processing block of a MFP;

FIG. 7 is a view showing a toner limit amount setup screen displayed on a control panel and a computer's display a via a printer driver; and

FIG. 8 is a flowchart to explain user setting for toner limit processing.

### DETAILED DESCRIPTION OF THE INVENTION

One embodiment of the present invention will be described below with reference to the accompanying drawings. This embodiment relates to a MFP (image forming apparatus) including an electro-photographic printer.

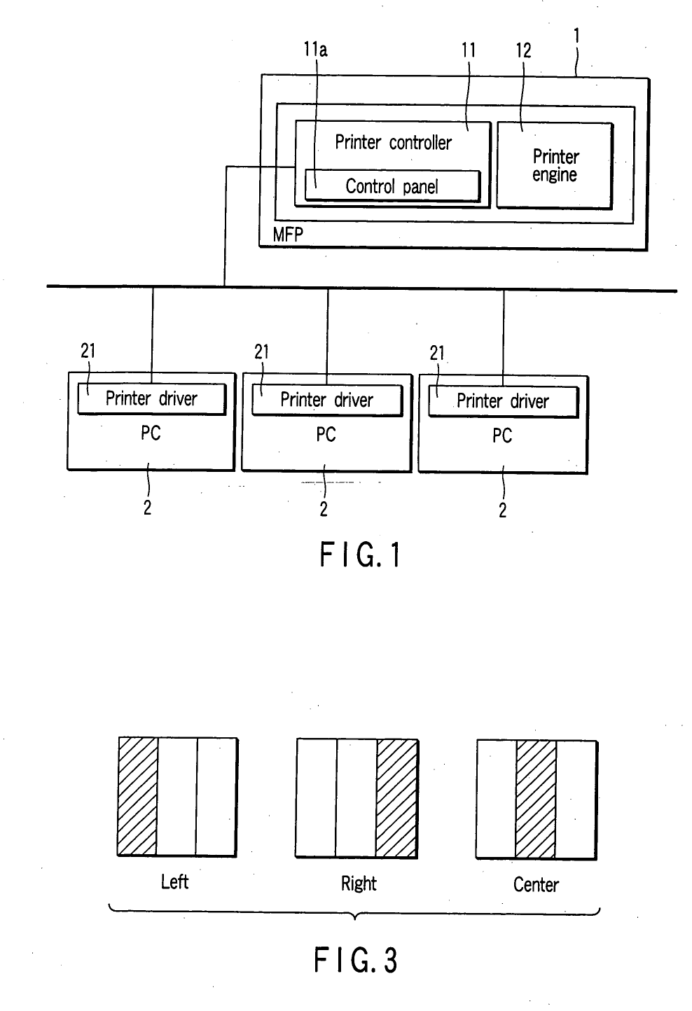

FIG. 1 is a block diagram schematically showing the configuration of a MFP and showing the environmental layout thereof.

A MFP 1 includes printer controller 11 and printer engine 12. The MFP 1 further includes a control panel 11a, which accepts various setting inputs with respect to the printer controller 11. Arbitrary computer terminals 2 (printer drivers 21) connected on a network transfer PDL data showing image data structure to the MFP 1. In other words, these computer terminals 2 transfers PDL code or raster data to the printer controller 11 of the MFP 1 in accordance with interface characteristic of the MFP 1 (printer).

The MFP 1 drives and controls the printer engine 12 using the printer controller 11. The printer controller 11 expands coded image data supplied from the computer terminals 2, that is, page description language such as PDL to bit-map. Then, the printer controller 11 executes various image processings, and thereafter, stores the page description language in a built-in image memory. The printer engine 12 converts bit-map image data supplied from the printer controller 11 into a drive signal. Then, the printer engine 12 carries paper and executes laser drive control to perform an image print operation. Moreover, the printer controller 11 analyzes the attribute of each object contained in image data using a RIP function. Then, the printer controller 11 executes the optimum image processing with respect to each object, and thereafter, synthesizes each object, and output it.

Incidentally, the computer terminal 2 and the MFP 1 are not necessarily connected via a network; in this case, the former and the latter may be connected via USB. In other words, the computer terminal 2 and the MFP 1 may be connected in one-to-one correspondence relationship. Each interface of the printer controller 11 and the printer engine 12 basically depends on the architecture of the MFP 1, and is not regulated in particular.

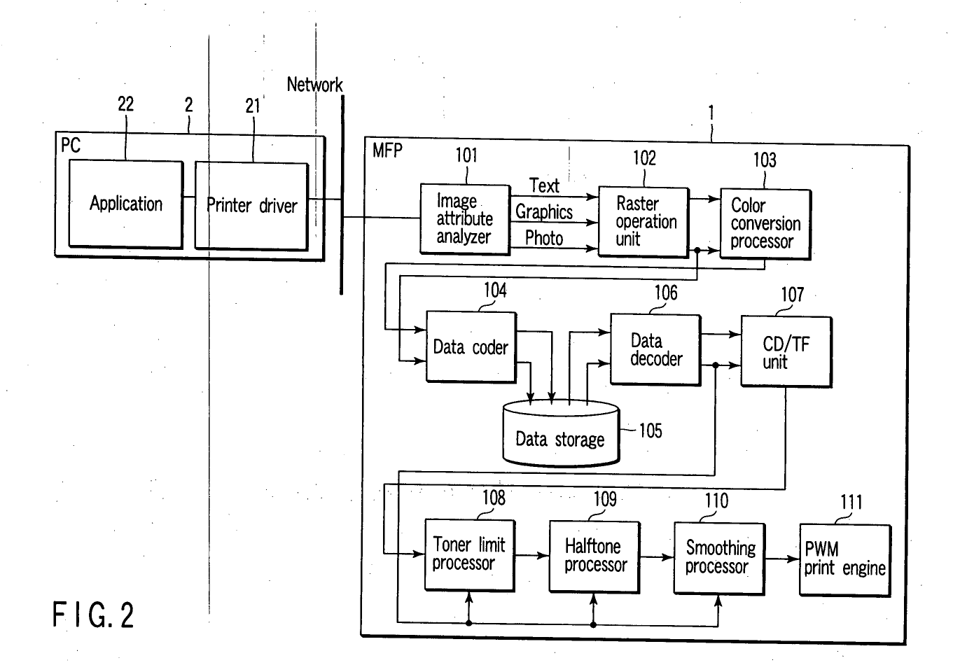

FIG. 2 is a view showing a first image processing block of the MFP. As shown in FIG. 2, the MFP 1 includes image attribute analyzer 101, raster operation unit 102, color conversion processor 103, data coder 104, data storage (memory) 105, data decoder 106 and CD/TF unit 107. The MFP 1 further includes toner limit processor 108, halftone processor 109, smoothing processor 110 and PWM print engine 111.

The printer driver 21 transfers PDL data to the MFP 1 based on a print instruction from the application 22. When receiving the PDL data, the printer controller 11 of the MFP 1 controls image forming based on the PDL data. The image forming control will be explained below.

The image attribute analyzer 101 analyzes the attribute of an object contained in the PDL data (image data) to classify the object. For example, the image attribute analyzer 101 is able to classify the object at a unit of one pixel data item or a predetermined number of pixel data items contained in the PDL data. The object contained in the PDL data is largely classified into any attribute of text object, graphics object and photo bit-map object. Based on the classified result, tag data showing object attribute is generated, and then, the tag data is supplied to after-stage various processors. For example, if the object is classified into the foregoing three attributes, 2-bit tag data is required.

The raster operation unit 102 converts the PDL data into bit-map data. For example, if the printer engine 12 is a color printer, the PDL data is converted into RGB 8-bit digital data. On the other hand, if the printer engine 12 is a monochrome printer, the PDL data is converted into single-color 8-bit digital data. In this case, the foregoing tag data is allocated to data corresponding to each pixel.

The color conversion processor 103 converts a standard RGB color signal on a RGB 8-bit monitor into printer reproducible CMY or CMYK color. In this case, the foregoing R, G and B show red, green and blue, respectively. Moreover, the foregoing C, M, Y and K show cyan, magenta, yellow and block, respectively. The color conversion processor 103 is configured to execute color conversion corresponding to each specified object based on the attribute shown by the tag data. If the printer engine 12 is a monochrome printer, the color conversion processor 103 is not required.

The data coder 104 compresses color-converted image data. In this case, it is desirable to employ a method of effectively compressing multi-level image data. Basically, an irreversible compression method is employed. The compressed image data is stored in the storage 105 such as memory and HDD. The image data is compressed, and thereby, the data capacity stored in the storage 105 is reduced; therefore, the performance of the MFP 1 is improved.

The data decoder 106 reads coded image data stored in the storage 105, and then, decodes the coded image data according to a predetermined procedure.

The CD/TF unit 107 makes γ-conversion for obtaining image density calibration corresponding to the characteristic of the printer engine 12 and favorite gradation characteristic. The CD/TF unit 107 is configured to make the optimum γ-conversion corresponding to the characteristic of each object based on the attribute shown by the tag data.

The toner limit processor 108 converts image data so that the toner supply amount of CMYK corresponding to CMYK of the printer engine 12 is within a predetermined limit range. The toner limit processor 108 is configured to execute the optimum toner limit processing corresponding to the characteristic of each object based on the attribute shown by the tag data.

The halftone processor 109 converts one-pixel data into image data by halftone processing using threshold matrix every CMYK color. In this case, the image data has gradation smaller than several bits for each color in accordance with the print capacity of the printer engine 12. The halftone processor 109 is configured to execute the optimum halftone processing corresponding to the characteristic of each object based on the attribute shown by the tag data.

The smoothing processor 110 executes pseudo high resolution conversion with respect to converts an image having actual resolution to smooth lines. Or, the smoothing processor 110 executes smoothing for reducing toner consumption using thinning. The smoothing algorithm is determined depending on specifications such as PWM divided frequency of the printer engine 12. The smoothing processor 110 is configured to execute the optimum smoothing corresponding to the characteristic of each object based on the attribute shown by the tag data.

A PWM print engine 16 converts finally generated image data supplied from the smoothing processor 110 into a PWM (Pulse Width Modulation) signal for driving laser. An image is formed using the laser driven according to the PWM signal. According to multi-level PWM, a position control signal is simultaneously generated based on the inputted image data. As illustrated in FIG. 3, if a halftone pixel is printed, the start position (standard) is controlled to become left and right (and center). In general, the start position is controlled to become left and right according to the position control signal, and thereby, image forming is possible. If the start position is high accurately controlled, a signal for controlling the start position to the center is used.

The toner limit processor 108 will be detailedly explained below.

In a color electro-photographic printer, if three or four color toners are locally arranged with a predetermined amount or more, a toner peel-off phenomenon calling offset happens. The phenomenon is a factor of remarkably reducing the image quality while giving damages to the printer engine 12. The following two methods are given as a method of solving the foregoing offset problem.

According to one method, when the color conversion processor 103 prepares a three-dimensional color conversion table, the three-dimensional color conversion table is prepared not to exceed a toner limit amount. According to another method, a toner limitation circuit is additionally provided. For example, if CMYK fill color (total of CMYK toner maximum outputs) is all set to 400% in the color electro-photographic printer; a 200 to 300% toner limit value (upper limit value) is set. The foregoing two methods may be combined to configure the system.

In the MFP 1, the latter method has attracted interest, and the toner limit processor 108 having the configuration shown in FIG. 5 changes the toner limit amount every object. In other words, the toner limit processor 108 changes the toner limit amount based on the attribute of each object. Specifically, the toner limit processor 108 limits the supply amount of CMYK toners based on graphic object, text object and bit-map object. By doing so, various effects can be obtained depending on design policy.

According to the method of adopting the toner limit amount in the three-dimensional color conversion table, the following problems arise. One is a problem of increasing the number of development process to prepare and adjust the three-dimensional color conversion table. Another is a problem that it is difficult to detect an arbitrary toner limit amount due to the foregoing problem. Another is a problem that huge and many three-dimensional color conversion tables are required to adapt to the arbitrary toner limit amount. Therefore, of course, it is unrealistic to control the toner limit amount using the color conversion processor 103 only. Incidentally, the color conversion processor 103 is able to prepare a three-dimensional color conversion table for controlling a basic toner limit amount. The toner limit processor 108 reduces toner consumption of non-sensitive object, and thereby, added value is given. As described above, the foregoing color conversion processor 103 and toner limit processor 108 are combined in its function, and thereby, flexible functions are obtained.

The added value of reducing toner consumption of non-sensitive object will be explained below. For example, according to PowerPoint (trademark) application, user often employs a method of coloring presentation background using high saturation color and deep blue graphic object to obtain good visual impression. If this presentation background is reproduced using a projector, very nice visual impression is obtained; therefore, there is no problem. However, if the document is printed with color, the toner consumption amount becomes very much. As a result, conversely, the document becomes too deep density; for this reason, there is a problem that the document is not visually impressive. Thus, according to general-purpose applications, there exists a mode of setting gray scale and simple black and white print. However, color information disappears in the mode.

The MFP 1 of the present invention limits the print density of background, which is not essentially important as information, to reduce a toner consumption amount. Specifically, the toner limit processor 108 changes a toner limit amount every object. For example, if a graphic object is recognized, the toner limit processor 108 sets the upper limit level of toner limit amount lower based on tag data showing the graphic object. Preferably, the upper limit level of toner limit amount is set to about 100 to 200%. In other words, the toner limit processor 108 sets the upper limit level of toner supply limit relevant to the graphic object lower than each upper limit level of toner supply limit relevant to text object and bit-map object. By doing so, the toner consumption amount is reduced. For example, if the upper limit level of the toner limit amount is set to 100%, the toner consumption is controlled to the same toner consumption amount as monochrome print.

Moreover, there is the case where image quality is reduced resulting from the foregoing toner consumption reduction. Specifically, the toner consumption amount of background (graphic object) is reduced, and thereby, the density difference becomes small between background and foreground (text object and bit-map object). As a result, characters and graphics of the foreground are hard to be seen. Namely, when the toner supply level with respect to the graphic object becomes lower than a predetermined level, the foregoing problem arises. In order to solve the problem, foreground data is inverted (R′=255−R, G′=255−G, B′=255−B), or the density is converted when the toner consumption amount of background is reduced. By doing so, the toner supply level with respect to the background becomes less than the predetermined level. On the contrary, the toner supply level with respect to the foreground is increased more than a normal toner supply level to clearly distinguish the background from the foreground. By doing so, it is possible to readily recognize significant information of the foreground. In general, the background has a far larger area than the foreground. For this reason, even if the toner supply level with respect to the foreground is increased more than a normal toner supply level, the toner consumption amount is reduced as the final result.

For example, the toner limit processor 108 sets a toner limit amount to character object having a relatively small print area to be covered to a lager value (i.e., sets the upper limit value of toner supply level higher). Moreover, the toner limit processor 108 sets a toner limit amount to fill object such as background having a relatively large print area to be covered to a small value (i.e., sets the upper limit value of toner supply level lower). Moreover, the toner limit processor 108 sets a toner limit amount to line object having a relatively small print area to be covered to a lager value (i.e., sets the upper limit value of toner supply level higher). Moreover, the toner limit processor 108 sets a toner limit amount to bit-map image making much of color reproduction to a lager value (i.e., sets the upper limit value of toner supply level higher). In the light of toner consumption amount, if the object has a relatively large print area to be covered, the toner limit amount value is made small (i.e., sets the upper limit value of toner supply level lower). Of course, the toner limit processor 108 can flexibly set the toner limit amount considering target market and design policy without being limited to the foregoing settings. User can freely set the foregoing setting of the toner limit amount via the control panel 11a. In addition, user can freely set the foregoing setting of the toner limit amount via the printer driver. Incidentally, the foregoing setting of the toner limit amount may be given as default. Namely, there exist various users, for example, user, who does not require color accuracy, or user, who is sensitive to cost. Therefore, an image forming apparatus having the following setting is delivered with respect to these users. According to the setting, a limit amount is variable, and set smaller as default. The foregoing individual user setting is possible.

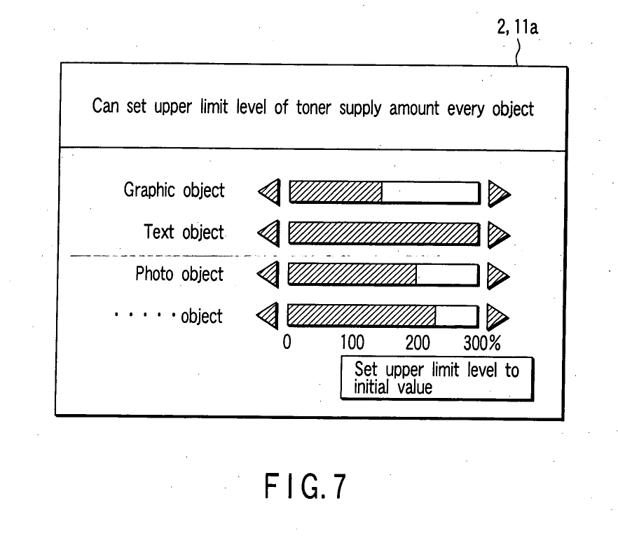

FIG. 7 is a view showing a toner limit amount setup screen displayed on the control panel 11a and on a display of the computer terminal 2 via a printer driver (image forming program).

User can set the upper limit level of toner supply amount in accordance with various objects via the toner limit amount setup screen. For example, user can set each upper limit level of toner supply amount with respect to graphic object, text object and bit-map objects via the toner limit amount setup screen.

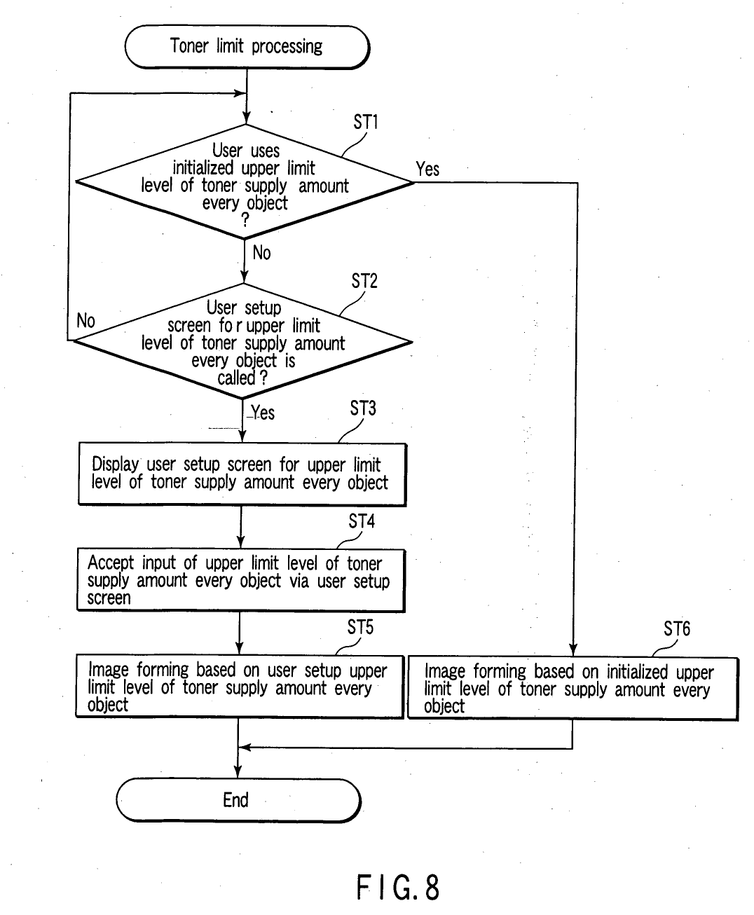

FIG. 8 is a flowchart to explain user setting for toner limit processing.

If user intactly uses an initialized upper limit level of toner supply amount every object (ST1, YES), no toner supply upper limit level setting is required in particular. In this case, image forming is carried out based on the initialized upper limit level of toner supply amount every object (ST6).

If user does not intactly uses the initialized upper limit level of toner supply amount every object, that is, user uses a upper limit level of toner supply amount every object according to user setting (ST1, NO). In this case, a user setup screen for upper limit level of toner supply amount every object is called via the control panel 11a or computer terminal 2 (ST2, YES). By doing so, as shown in FIG. 7, a user setup screen for upper limit level of toner supply amount every object is displayed on the control panel 11a or computer terminal 2 (ST3). When input of the upper limit level of toner supply amount every object is accepted via the user setup screen (ST4), image forming is carried out based on the user setup upper limit level of toner supply amount every object (ST5).

The use for tag data will be explained below. The tag data is inputted to color conversion processor 103, CD/TF unit 107, halftone processor 109 and smoothing processor 110. Based on this configuration, the following processings are combined, thereby totally reducing the toner consumption amount, and obtaining effect. One is toner consumption amount reduction processing by the toner limit processor 108 using the tag data. Another is processing by color conversion processor 103, CD/TF unit 107, halftone processor 109 and smoothing processor 110 using the tag data. For example, considering gamut mapping algorithm of the color conversion processor 103, that is, various characteristics such as perceptual, relative, saturation and absolute, the toner limit amount is controlled. By doing so, the toner consumption amount is reduced in the most preferable state of color reproduction. Moreover, according to the combination with the processing by the CD/TF unit, it is possible to readily realize a design for reducing quantization error so that digital gradation reproduction is substantially reduced. If the toner limit amount is further limited (i.e., upper limit level of toner limit amount is set lower), the density difference of the foreground object is largely kept using a γ-curve making deep the density of character object. By doing so, it is possible to readily distinguish the foreground object from the character object. According to the combination with the halftone processor 109, a screen considering concatenation between output pattern colors is designed, and thereby, the consumption amount of toner keeping particle density. According to the combination with the smoothing processor 110, it is possible to prevent jaggy from occurring in an output pattern after smoothing.

In addition to the combination of two processings by the toner limit processor 108 and other arbitrary processor, arbitrary several processings may be combined.

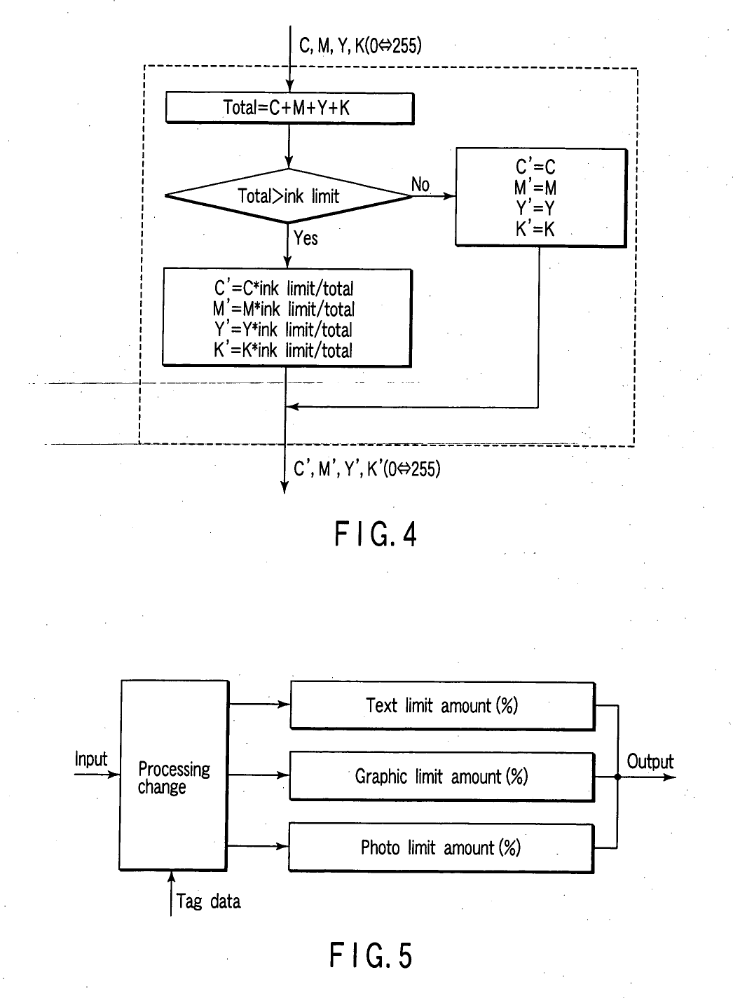

Basically, the processing algorithm of the toner limit processor 108 is realized using various methods. For example, the processing algorithm is readily realized using arithmetic operation shown in FIG. 4.

In the MFP 1 shown in FIG. 2, the toner limit processor 108 is provided near the PWM print engine 111 of the after-stage of the data storage 105. Thus, toner limit processing is applied to various data stored in the data storage 105, for example, copier and scanner image data used for a BOX function, in addition to printer data.

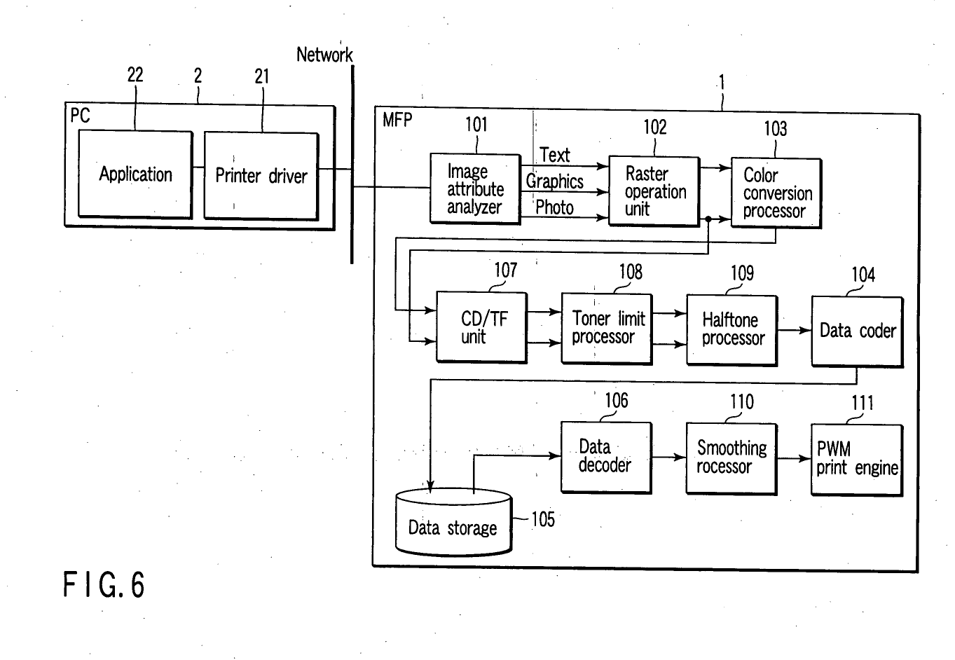

FIG. 6 is a view showing the configuration of a second image processing block of a MFP. According to the configuration of the MFP 1 shown in FIG. 2, the toner limit processor 108 is arranged at the after-stage of the data storage 105. On the contrary, according to the configuration of a MFP 1 shown in FIG. 6, a toner limit processor 108 is arranged at the pre-stage of a data storage 105. By doing so, the toner limit processor 108 of the MFP 1 shown in FIG. 6 processes printer data. Incidentally, pass from copier or scanner is connected to the toner limit processor 108, and thereby, toner limit processing is applied to copier or scanner image data. Moreover, according to the configuration of the MFP 1 shown in FIG. 6, image data after halftone processing is compressed, and thereafter, stored in the data storage 105. As a result, the data storage 105 stores reversible and high compression image data; therefore, this contributes to cost reduction of system in the light of storage capacity.

As described above, the toner limit processor 108 of the MFP 1 can readily control toner limit amount every object. Therefore, the MFP 1 has simple hardware configuration, and properly reduces toner consumption amount.

The foregoing description relates to the case where the toner limit processor 108 is applied on the way to the process of specific image processing. However, the present invention is not limited to the foregoing case. For example, the toner limit processor 108 may be applied to a process of arbitrary image processing. Moreover, three, text, graphic and bitmap are given as the object; in this case, objects other than above may be added as a target. The target object may be reduced to two. It is easily imagined to readily realize the foregoing modifications.

Therefore, the MFP 1 is simply configured, and further, a proper toner amount is controlled with respect to each object using the toner limit processor 108 of the MFP 1 solely. Moreover, the toner limit processor 108 of the MFP 1 is combined with other processing block, and thereby, a proper toner amount is effectively controlled with respect to each object. Even if the MFP 1 is provided with the toner limit processor 108, no influence is given to other processing blocks. Therefore, system development efficiency is improved, and total cost is reduced.

The foregoing embodiment has explained about the case where a function of carrying out the invention (toner limit processing) is previously recorded in the apparatus. However, the present invention is not limited to this embodiment; for example, the same function as above may be downloaded to the apparatus from a network. The same function may be installed in the apparatus using a recording medium storing the same. The recording medium may be any other form so long as it stores program such as CD-ROM and is readable by the apparatus. The function previously obtained by install or download may be realized in cooperation with OS (operating system) of the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image forming apparatus comprising:
an analyzer analyzing an attribute of an object contained in image data;
a toner limiter limiting a supply of several toners corresponding to several color components based on an attribute of the object analyzed by the analyzer; and
an image forming unit forming an image based on an object contained in the image data using the toner limited by the toner limiter.

2. The image forming apparatus according to claim 1, wherein the toner limiter limits the supply of the several toners corresponding to pixel data items contained in the image data at a unit of one pixel data item or a predetermined number of pixel data items.

3. The image forming apparatus according to claim 1, wherein the analyzer analyzes graphic object, text object and bit-map object contained in the image data, and
the toner limiter limits the supply of the several toners corresponding to the several color components based on the graphic object, the text object and the bit-map object analyzed by the analyzer.

4. The image forming apparatus according to claim 3, wherein the toner limiter limits the supply of the several toners corresponding to the several color components based on the graphic object equivalent to an image background.

5. The image forming apparatus according to claim 3, wherein the toner limiter sets an upper level of the toner supply limit with respect to the graphic object lower than each upper level of the toner supply limit with respect to the text object and the bit-map object.

6. (canceled)

7. The image forming apparatus according to claim 3, wherein the toner limiter sets each toner supply level with respect to the text object and the bit-map object higher than a normal toner supply level under a condition that a toner supply level with respect to the graphic object becomes lower than a predetermined level according to the toner supply limit with respect to the graphic object equivalent to an image background.

8. The image forming apparatus according to claim 7, wherein the toner limiter sets each toner supply level with respect to the text object and the bit-map object higher than the normal toner supply level according to data inversion processing.

9. The image forming apparatus according to claim 1, further comprising:
a storage storing the image data,
the toner limiter limiting the supply of the several toners corresponding to the several color components based on an attribute of the object contained in the image data stored in the storage.

10. The image forming apparatus according to claim 1, further comprising:
a storage storing the image data containing the object on which the toner limit by the toner limiter is reflected,
the image forming unit forming an image based on the image data containing the object the toner limit stored in the storage is reflected.

11. The image forming apparatus according to claim 1, further comprising:
an image processing unit processing image data based on an attribute of the object contained in the image data,
the image forming unit forming the image based on the object contained in the image data processed by the image processing unit using the toner limited by the toner limiter.

12. An image forming apparatus comprising:
an input setting unit setting an input of toner supply limit data for limiting a supply of several toners corresponding to several color components based on an attribute of an object contained in image data;
an analyzer analyzing an attribute of the object contained in the image data;
a toner limiter limiting the supply of several toner corresponding to several color components based on the toner supply limit data set by the input setting unit and the attribute of the object analyzed by the analyzer; and
an image forming unit forming an image based on the object contained in the image data using the toner limited by the toner limiter.

13. The image forming apparatus according to claim 12, wherein the input setting unit sets the input of the toner supply limit data every graphic object, text object and bit-map object contained in the image data.

14. An image forming program comprising:
a procedure of setting an input of toner supply limit data for limiting a supply of several toners corresponding to several color components based on an attribute of an object contained in image data; and
a procedure of outputting an instruction to form an image based on the object contained in the image data using a toner limited by the toner supply limit data.

15. The image forming program according to claim 14, further comprising:
a procedure of setting the input of the toner supply limit data every graphic object, text object and bit-map object contained in the image data.

16. An image forming method comprising:
analyzing an attribute of an object contained in image data;
limiting the supply of several toners corresponding to several color components based on an attribute of the analyzed object; and
forming an image based on an object contained in the image data using the limited.
